(19) United States
(12) Patent Application Publication
(10) Pub. No.: US 2026/0245359 A1
(43) Pub. Date: Aug. 20, 2026

(54) AUTOMATIC ALERT SYSTEM OF BURIED CABLES EXPOSURE USING HIERARCHAL RESOLUTION SATELLITE REMOTE SENSING AND AERIAL IMAGERY

(71) Applicant: Saudi Arabian Oil Company, Dhahran (SA)

(72) Inventors: Ahmed Aljarro, Thuwal (SA); Frankly Leonardo Toro Gonzalez, Thuwal (SA); Omar Bajowaiber, Yanbu (SA); Ali Alshehri, Thuwal (SA); Hamad Alsaiari, Al-Khobar (SA); Saidkhodzha Nematulloev, Thuwal (SA)

(21) Appl. No.: 19/055,847

(22) Filed: Feb. 18, 2025

(51) Int. Cl. G06V 20/13; B64G 1/10; G06V 10/25; G06V 10/764; H04N 7/18

(52) U.S. Cl. CPC G06V 20/13; B64G 1/1028; G06V 10/25; G06V 10/764; B64G 1/1035; G06V 2201/10; H04N 7/183

(57) ABSTRACT

Data corresponding to a region of interest is received. The data includes remote sensing images of a region of interest and metadata includes information indicative of a set resolution of the remote sensing images. The region of interest includes buried cables. A cable exposure risk within a portion of the region of interest is determined. An additional image at an updated resolution higher than the set resolution is requested; an additional data includes additional remote sensing images corresponding to the portion of the region of interest is received. The additional remote sensing images are processed to classify an exposure of at least a portion of a buried cable. A control signal causing a remote device to remedy the exposure of the at least the portion of the buried cable is generated to prevent data loss for data transmitted over the at least the portion of the buried cable.

### TECHNICAL FIELD

The present disclosure is generally related to identification of terrain changes and, more specifically, to identification of buried cables exposure using hierarchal resolution satellite remote sensing and aerial imagery.

### BACKGROUND

Optical communication networks are typically housed in cables containing bundles of glass or plastic strands known as optical fibers. The fibers carry digital data signals converted into light, which is transmitted along the fiber optic network. The integrity of the communication cables is crucial for maintaining uninterrupted data transmission, spanning vast terrestrial landscapes, including both land and sea. Optical fibers are essential for long-distance data transfer, capable of transmitting data over extensive distances including challenging terrains, such as sand and rocky mountains. Most optical fibers include protection layers to maintain signal integrity through harsh conditions like extreme heat, rain, sand shifts, and erosion. The protection layers can include a buffer coating and shields against physical damage and environmental factors. The shields can form strength members, such as aramid yarn or steel wires, provide tensile strength, while an outer cable jacket made of materials like polyethylene protects against environmental hazards. The fibers can be protected against extreme conditions, by armored layers of steel or aluminum. The fibers can be protected by water-blocking materials that prevent moisture ingress, ensuring fiber longevity. Despite the protective layers, the cables can become vulnerable to environmental hazards or interactions with humans and animals when exposed.

### SUMMARY

Implementations of the present disclosure are directed to identification of terrain changes. More particularly, implementations of the present disclosure are directed to unsupervised identification of buried cables exposure using hierarchal resolution satellite remote sensing and aerial imagery.

In some implementations, a method includes: receiving data corresponding to a region of interest, the data including remote sensing images of a region of interest and metadata including information indicative of a set resolution of the remote sensing images, the region of interest including at least partially buried cables, determining, by processing the data, a cable exposure risk within a portion of the region of interest, requesting an additional image at an updated resolution higher than the set resolution, receiving an additional data including additional remote sensing images corresponding to the portion of the region of interest, processing the additional remote sensing images to classify an exposure of at least a portion of a buried cable, and generating a control signal causing a remote device to remedy the exposure of the at least the portion of the buried cable and prevent data loss for data transmitted over the at least the portion of the buried cable.

The foregoing and other implementations can each optionally include one or more of the following features, alone or in combination. In particular, implementations can include all the following features:
In a first aspect, combinable with any of the previous aspects, wherein the remote sensing images include low resolution satellite images, mid-resolution satellite images, and high-resolution satellite images. The computer-implemented method includes determining that additional remote sensing images are acquirable at the updated resolution. The computer-implemented method includes generating a trigger to acquire additional remote sensing images at the updated resolution, higher than the set resolution. The computer-implemented method includes in response to determining that the set resolution is a maximum resolution of the satellite images, generating a trigger to deploy an unmanned aerial device to the region of interest, receiving a confirmation of the exposure of the at least the portion of the buried cable, and generating an alert indicative of the exposure of the at least the portion of the buried cable. The computer-implemented method includes deploying a machine to the region of interest. Classifying the exposure of the at least the portion of the buried cable includes determining a damage of cable protection layer and a length of cable exposure.

Other implementations of the aspect include corresponding systems, apparatus, and computer programs, configured to perform the actions of the methods, encoded on computer storage devices.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features described herein, but also include any combination of the aspects and features provided.

Implementations described in the present disclosure, provide an accurate identification of exposed cables, facilitating monitoring mechanisms to ensure the reliable and continuous operation of communication networks based on optical fibers. The described approach provides efficient extraction and analysis of terrain change patterns, using hierarchal resolution satellite remote sensing and aerial imagery, resulting in more accurate cable exposure identification. The cable exposure identification improvement of the described implementations is particularly significant for maintaining data transmission operations in response to terrain changes that can expose cables, such as land degradation, ecosystem changes, soil condition changes, and operational infrastructures. Another advantage of the described technology is that the described mapping of materials facilitates identification of terrain changes that can be widely distributed and can exhibit diverse patterns due to the complexity of wind regimes, sediment availability, and the lack of effective preventative measures. The described technology substantially improves over existing methods in that it automatically analyzes in real time, vast surfaces to identify clues indicative of cable exposure that would not be apparent to a person reviewing the images. The timely identification of cable exposure advantageously facilitates activation of effective preventative measures to avoid and/or correct cable exposure and maintain data communication. Another advantage of the described technology is that the automatic activation of preventative measures can include triggering of automatic operations for systems and machines configured to maintain reliable and continuous data transmission and environmental safety.

The details of one or more implementations of the subject matter of the specification are set forth in the accompanying drawings and the description below. Other features, aspects, and advantages of the subject matter can become apparent from the description, the drawings, and the claims.

### DESCRIPTION OF THE DRAWINGS

The accompanying drawings, which are incorporated in and constitute a part of this specification, show particular aspects of the subject matter disclosed herein and, together with the description, help explain some of the principles associated with the disclosed implementations. In the drawings,

FIG. 1A is a block diagram of an example system that can be used to execute implementations of the present disclosure.

FIG. 1B is a block diagram of a portion of the example system that can be used to execute implementations of the present disclosure.

FIG. 2A illustrates an example of an image at a first resolution, according to some implementations of the present disclosure.

FIG. 2B illustrates an example of an image at a second resolution, according to some implementations of the present disclosure.

FIG. 2C illustrates an example of an image at a third resolution, according to some implementations of the present disclosure.

FIG. 3 is a flowchart illustrating an example process for cable exposure identification, in accordance with some example embodiments.

FIG. 4 depicts a block diagram illustrating a computing system, in accordance with some example embodiments.

When practical, like labels are used to refer to same or similar items in the drawings.

### DETAILED DESCRIPTION

The following detailed description describes techniques for terrain change identification. More particularly, implementations of the present disclosure are directed to identification of buried cables exposure using hierarchal resolution satellite remote sensing and aerial imagery. The described implementations provide methods and systems for automatic detection of terrain change with adverse impact on critical areas of interest hosting buried cables, for example optical fibers. The image processing workflow includes a multi-step detection-classification based on hierarchal resolution satellite remote sensing (SRS) data acquisition combined with aerial imagery, for regions of interest. The multi-step detection-classification can combine initial low-resolution SRS data, followed by mid-range resolution SRS monitoring, and higher-range resolution SRS and aerial imagery, for automatic detection of critically impacted areas of interest including potentially exposed cablers. The multi-step cable exposure detection can prompt immediate remedial actions.

Terrain changes can have a significant impact on many operations. The terrain changes that can affect cable-based communication networks include land degradation, threats to ecosystems, soil conditions, and operational infrastructures. Terrain changes are extensively distributed and display diverse patterns resulting from the complexity of the wind regimes and sediment distribution. Terrain changes can also be caused by the absence of effective preventative measures. Comprehensive mapping of landscapes can facilitate monitoring of environments that evolve in response to various and continuously evolving conditions from climate and geomorphic changes to man-introduced interventions and/or constructions.

Some traditional studies of terrain change patterns have utilized local field survey. However, manual approaches are resource exhaustive, and restrictive for challenging terrains, being limited to easy to reach landscapes. Moreover, a manual mapping process involves subjective interpretation, introducing unfavorable errors. Such traditional identification systems provide limited results and depend on extensive resources. Difficulties in identifying buried cable exposure, using traditional identification technologies, are associated with the distribution surface of cable networks including challenging terrain. The communication networks can require strict checking mechanisms to ensures adequate and reliable monitoring of data transmission to ensure continuous data supply.

The techniques described in the present disclosure provide a systematic and automated image processing technique, addressing the challenge of traditional techniques in identification of terrain changes that can lead to cable exposure. The described approach is based on satellite remote sensing that minimizes restrictions related to challenging terrain associated to traditional methods. Satellite images can be collected from various satellite imagery providers operating at a set frequency and on a regular basis. The described approach based on satellite remote sensing facilitates consistent monitoring of an area of interest. The described remote sensing methods include calculating pixel displacement for the interpretation of features. The monitored terrain changes include of a mixture of natural features with varying composition and size, resulting in different spectral signatures. The described methods include detection of variations in spectral reflectance of pixels of images to identify features of interest associated with cable exposure. The detection of the variations includes a combination of processing initial low-resolution SRS data, followed by mid-range resolution SRS monitoring, and higher-range resolution SRS and aerial imagery. Image processing of different resolution images enhances resource usage on an as-needed basis, enabling accurate identification of terrain changes that can lead to cable exposure.

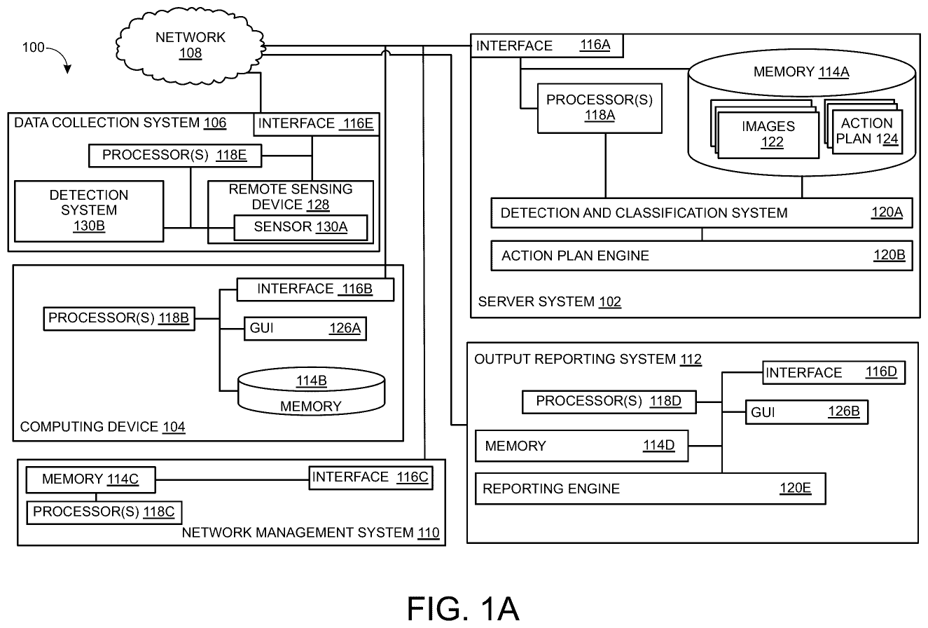

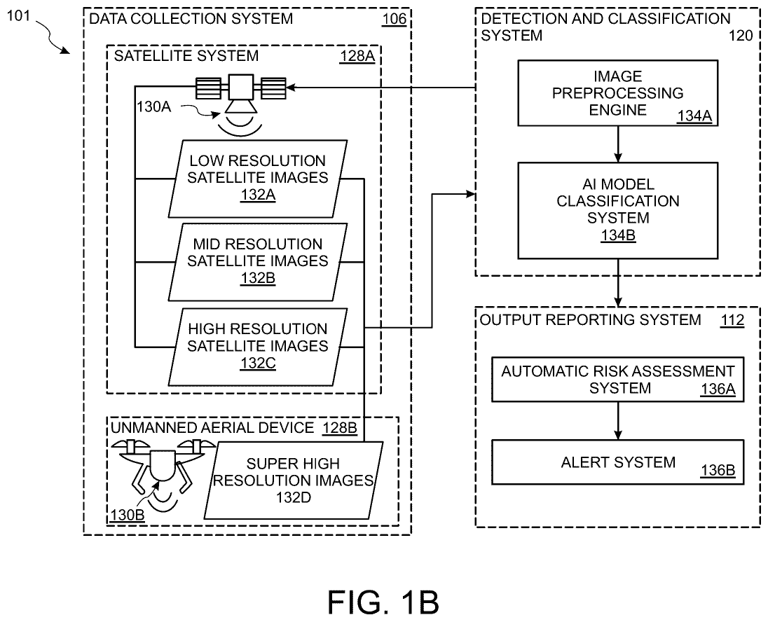

FIG. 1A is a block diagram illustrating an example system 100 that can be used to execute implementations of the present disclosure. For example, example system 100 can be configured to execute clustering algorithms for extraction of a complete hierarchy of materials present in a multi- or hyperspectral image. The illustrated example system 100 includes or is communicably coupled with a server system 102, a computing device 104, a data collection system 106, a network 108, a network management system 110, and an output reporting system 112. Although shown separately, in some implementations, functionality of two or more systems or components of the example system 100 may be provided by a single system or server. In some implementations, the functionality of one illustrated system, server, or component may be provided by multiple systems, servers, or components, respectively.

In the example of FIG. 1A, the server system 102 is intended to represent various forms of servers including, but not limited to a web server, an application server, a proxy server, a network server, and/or a server pool. In general, the server system 102 manages clustering algorithms for unsupervised segmentation of multispectral images. In accordance with implementations of the present disclosure, and as noted above, the server system 102 can host a solution environment that can be a cloud environment providing software applications, systems, and services that can be consumed by customers as a service. In some implementations, the server system 102 can support configuring of various tenants of different types, as well as services of different types that are integrated in customer integration scenarios and support execution of defined processes.

For example, the server system 102 includes a memory 114A, an interface 116A, a processor 118A, and a detection and classification system 120A and an action plan engine 120B. The memory 114A can include multispectral images 122 and action plans 124. The multispectral images 122 include data measured by and received from the data collection system 106. The multispectral images 122 can include images detected by aerial sensors. The multispectral images 122 can be processed by the detection and classification system 120A to generate material maps that are processed by the action plan engine 120B to generate action plans 124. The action plans 124 in the memory 114A can include action plan documents defining remedial operations performed by systems and machine for management and redistribution of materials.

The computing device 104, the network management system 110, and the output reporting system 112 may each be any computing device operable to connect to or communicate in the network(s) 108 using a wireline or wireless connection. In general, each of the computing device 104, the network management system 110, and the output reporting system 112 includes an electronic computer device operable to receive, transmit, process, and store any appropriate data associated with the example system 100 of FIG. 1A. Each of the computing device 104, the network management system 110, and the output reporting system 112 can encompass any client computing device such as a laptop/notebook computer, wireless data port, smart phone, personal data assistant (PDA), tablet computing device, one or more processors within these devices, or any other suitable processing device. The computing device 104, the network management system 110, and the output reporting system 112, respectively include interface(s) 116B, 116C, 116D, processor(s) 118B, 118C, 118D, and memories 114B, 114C, 114D.

The computing device 104 and the output reporting system 112, respectively, include graphical user interface(s) (GUIs) 126A and 126B. For example, the GUIs 126A, 126B include an input device, such as a keypad, touch screen, or other device that can accept user information, and an output device that conveys information associated with the operation of the server system 102, or the client device itself, including a display of the material maps and action plan operations selected based on the material movement patterns. The GUIs 126A, 126B each interface with at least a portion of the example system 100 for any suitable purpose, including generating a visual representation of the multispectral images collected by the data collection system 106, the material maps generated by the server system 102, or data stored by the server system 102, such as multispectral images 122 and action plans 124, respectively. In particular, the GUIs 126A, 126B may each be used to view and adjust various action plans. Generally, the GUIs 126A, 126B each provide the user with an efficient and user-friendly presentation of the material maps and action plans including material movement patterns communicated within the example system 100. The GUIs 126A, 126B may each include multiple customizable frames or views having interactive fields, for selection of regions of interest and/or display of material maps for different regions and time points. The GUIs 126A, 126B can each be any suitable graphical user interface, such as a combination of a generic web browser, intelligent engine, and command line interface (CLI) that processes information and efficiently presents the results to the user visually.

The output reporting system 112 can include a reporting engine 120C, the GUI 126B (dashboard), an interface 116D, and a processor 118D. The reporting engine 120C utilizes the analytics data provided by the action plan engine 120B to produce executive and semi executive level displays for the GUI 126B. The GUI 126B displays a high-level summary of a material map assessment, which provides support for material movement patterns in addition to key recommended actions for environment and industrial plant safety and continuous operability. The GUI 126B display can facilitate material distribution monitoring and decision makers to modify (operations of) the systems and machines selected for cleaning identified materials.

The data collection system 106 can include multiple imaging sensors 130A and a detection system 130B. The imaging sensors 130A can be within a remote sensing device 128 (e.g., attached to or included in the remote sensing device), acquiring samples and data during a flight or hovering operation. The remote sensing device 128 can be a satellite system and/or an unmanned remote sensing device. The imaging sensors 130A can be configured to acquire images at multiple resolutions: low, mid-range, high, and, optionally, ultra-high. The low-resolution satellite images with can include a representation of hundreds of meters per pixel. The mid-range resolution satellite images with can include a representation of 5-100 meters per pixel. The high-resolution satellite images with can include a representation of 1-5 meters per pixel. Images acquired by sensors attached to unmanned remote sensing devices can have a super-high resolution of submeter information (e.g., centimeters or millimeters) per pixel. The imaging sensors 130A and the detection system 130B can include any of a hyperspectral sensor, spectroradiometers (e.g., ultraviolet/visible/near infrared/short wave infrared spectroradiometers), a camera, and other types of probes. The processor 118E of the data collection system 106 controls operation of the imaging sensors 130A and the detection system 130B and directs collected and determined data to the server system 102 for storage, further analysis, and modelling. The imaging sensors 130A and the detection system 130B can collect multispectral images of one or more areas of interest below the remote sensing device 128. Further details about the imaging sensors 130A and the detection system 130B and their operation are provided with reference to FIG. 1B.

In some implementations, the network 108 can include a large computer network, such as a local area network, a wide area network, the Internet, a cellular network, a telephone network, or any appropriate combination thereof connecting any number of communication devices, mobile computing devices, fixed computing devices and server systems. Data exchanged over the network 108, is transferred using any number of network layer protocols, such as Internet Protocol, Multiprotocol Label Switching, Asynchronous Transfer Mode, Frame Relay, etc. Furthermore, in implementations where the network 108 represents a combination of multiple sub-networks, different network layer protocols are used at each of the underlying sub-networks. In some implementations, the network 108 represents one or more interconnected internetworks, such as the public Internet.

Each processor 118A, 118B, 118C, 118D, 118E included in different components of the example system 100 can include a central processing unit, an application particular integrated circuit, a field-programmable gate array, or another suitable component. Generally, each processor 118A, 118B, 118C, 118D, 118E executes instructions and manipulates data for material classification. Each processor 118A, 118B, 118C, 118D, 118E executes a functionality required to monitor multispectral images associated to a remote sensing device 128, to monitor and correct material movement patterns.

Interfaces 116A, 116B, 116C, 116D, 116E are used by different components of the example system 100 for communicating with other component systems in a distributed environment—including within the example system 100—connected to the network 108. Generally, the interfaces 116A, 116B, 116C, 116D, 116E each include logic encoded in software and/or hardware in a suitable combination and operable to communicate with the network 108. More specifically, the interfaces 116A, 116B, 116C, 116D, 116E may each include software supporting one or more communication protocols associated with communications such that the network 108 or interface's hardware is operable to communicate physical signals within and outside of the illustrated system 100.

The memory 1114A, 114B, 114C, 114D may include any type of memory or database module and may take the form of volatile and/or non-volatile memory including, without limitation, magnetic media, optical media, random access memory, read-only memory, removable media, or any other suitable local or remote memory component. The memory 1114A, 114B, 114C, 114D may store various objects or data, including caches, classes, frameworks, applications, backup data, business objects, jobs, web pages, web page templates, database tables, database queries, repositories storing images 122 (e.g., multispectral images and/or dynamic information, and any other appropriate information including material movement pattern models, and any material cleaning parameters, variables, algorithms, instructions, rules, constraints, or references thereto) associated with the purposes of the server system 102, the computing device 104, the data collection system 106, the network management system 110, and the output reporting system 112, respectively.

There may be any number of computing devices 104 and data collection systems 106 associated with, or external to, the example system 100. Additionally, there may also be one or more additional client devices external to the illustrated portion of system 100 that are configured for interacting with the example system 100 via the network(s) 108. Further, the term “client,” “client device,” and “user” may be used interchangeably as appropriate without departing from the scope of the disclosure. Moreover, while client device may be described in terms of being used by a single user, the disclosure contemplates that many users may use one computer, or that one user may use multiple computers. As used in the present disclosure, the term “computer” is intended to encompass any suitable processing device. For example, although FIG. 1A illustrates a single server system 102, a single computing device 104, a single data collection system 106, a single network management system 110, the example system 100 can be implemented using a single, stand-alone computing device, two or more core systems 102, or multiple client devices. The server system 102, the computing device 104 and the output reporting system 112 may include any computer or processing device such as, for example, a blade server, general-purpose personal computer, workstation, or any other suitable device. In other words, the present disclosure contemplates computers other than general purpose computers, as well as computers without conventional operating systems. Further, the server system 102 and the computing device 104 and the output reporting system 112 may be adapted to execute any operating system or runtime environment. According to one implementation, the server system 102 may also include or be communicably coupled with an e-mail server, a Web server, a caching server, a streaming data server, and/or another suitable server, as described with reference to FIG. 1B.

FIG. 1B is a block diagram of a portion of the example system 100 that can be used to execute implementations of the present disclosure. In particular, FIG. 1B depicts a schematic diagram illustrating an example portion 101 of a variation of the example system 100 described with reference to FIG. 1A, in accordance with some example embodiments. The example portion 101 of the example system 100 illustrated in FIG. 1B includes the data collection system 106, a detection and classification system 120A, and an output reporting system 112.

The data collection system 106 can include one or more remote sensing devices, such as a satellite system 128A and an unmanned aerial device 128B. The satellite system 128A can include or can be coupled to an imaging sensor 130A. The unmanned aerial device 128B can include or can be coupled to an imaging sensor 130B. The imaging sensors 130A and the detection system 130B are communicatively connected to the processor 118E. The imaging sensors 130A, 130B can include red, green, blue (RGB) imaging devices, multispectral sensors, and hyperspectral sensors (e.g., infrared imaging spectrometers), or other imaging systems facilitating the collection of images 132A, 132B, 132C, 132D of terrains at different resolutions (low, medium, high, and ultra-high resolution). The images 132A, 132B, 132C, 132D can include optical images, synthetic aperture radar (SAR) images, interferometric SAR (InSAR) images, infrared (IR) images, and/or multi/hyperspectral images multispectral images of multiple regions of interest. The data collection system 106 can generate triggers according to a particular schedule to control image collection executed by the imaging sensors 130A, 130B. The data collection system 106 can transmit the collected images 132A, 132B, 132C, 132D by the imaging sensors 130A, 130B to the detection and classification system 120 for processing.

The detection and classification system 120A includes an image preprocessing engine 134A and an artificial intelligence (AI) model classification system 134B. The image preprocessing engine 134A executes pre-processing of the multiresolution images 132A, 132B, 132C, 132D to enhance data quality and can ensure accurate downstream analysis. The image preprocessing engine 134A can execute one or more alignment and filtering techniques. For example, image preprocessing engine 134A can execute noise correction to remove sensor noise using correction coefficients during image processing. As another example, image preprocessing engine 134A can execute vignetting correction to address uneven illumination across the image caused by lens vignetting. As another example, image preprocessing engine 134A can execute lens distortion correction to apply distortion models (such as the brown model) to correct lens-induced distortions; band registration to align spectral bands to ensure consistent spatial information. As another example, image preprocessing engine 134A can execute radiometric correction to normalize pixel values to account for variations in sensor sensitivity. The filtering applied by the image preprocessing engine 134A can apply any of a multidimensional edge detection filter, a multidimensional 9-point Laplacian filter and can generate a volatility map and a locally normalized edge index. The image preprocessing engine 134A can adjust the applied preprocessing techniques based on the received image resolution and based on the sensor that acquired respective images to optimize data quality, enabling accurate material monitoring and cable exposure detection.

The artificial intelligence (AI) model classification system 134B can receive preprocessed images, from the image preprocessing engine 134A. The artificial intelligence (AI) model classification system 134B can differentially apply trained classification and identification models corresponding to a particular resolution of the preprocessed image. The AI model classification system 132C can process low resolution images of a particular region, corresponding to multiple time points to identify material changes that can lead to cable exposure. The AI model classification system 132C can process mid-resolution images of a particular region, corresponding to multiple time points to identify potential indications of cable exposure. The AI model classification system 132C can process high resolution images of a particular region, to identify cable exposure. The AI model classification system 132C can process ultra-high-resolution images of a particular region, to quantify cable exposure. The AI model classification system 132C can include machine learning techniques (e.g., neural networks) trained to analyze spatial data and reveal soil patterns associated with cable exposure.

The output reporting system 112 includes an automatic risk assessment system 136A and an alert system 136B. The automatic risk assessment system 136A can process the cable exposure and generated measurements to identify a potential damage to the exposed cable. The automatic risk assessment system 136A can determine an immediate and a long-term risk associated to a respective communication network including the exposed cable, the risk level depending on the damage to the exposed cable. The automatic risk assessment system 136A can classify the determined risk. The alert system 136B can include a GUI (e.g., GUI 126 described with reference to FIG. 1A) to generate displays indicating the identified risk. The alert system 136B can receive, from the automatic risk assessment system 136A, the determined risk, and can generate a trigger to send to a machine or a device to perform a remedial action (e.g., protect the cable by applying protection layers, prepare a site, rebury the exposed cable, backfill the trench, and install reference markers). For example, the system 100 can send a control signal to a remote system (e.g., unmanned terrain vehicle) triggering a displacement to a location of the cable exposure and specifies a respective remedial action for mitigation.

While portions of the example system 100 illustrated in FIGS. 1A and 1B are shown as individual modules that implement the various features and functionality through various objects, methods, or other processes, the hardware components can execute software that can include multiple sub-modules, third-party services, components, libraries, and such, as appropriate. Conversely, the features and functionality of various components can be combined into single components as appropriate.

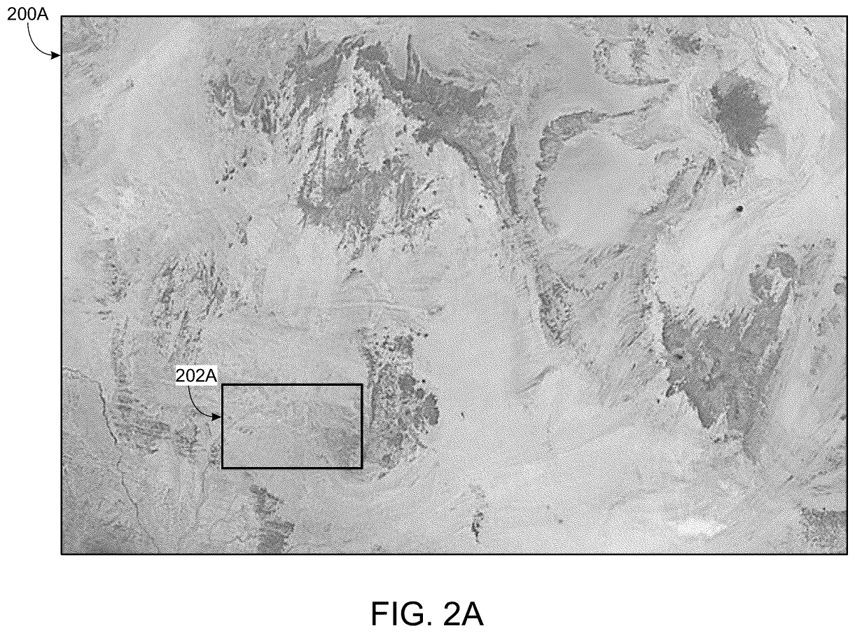

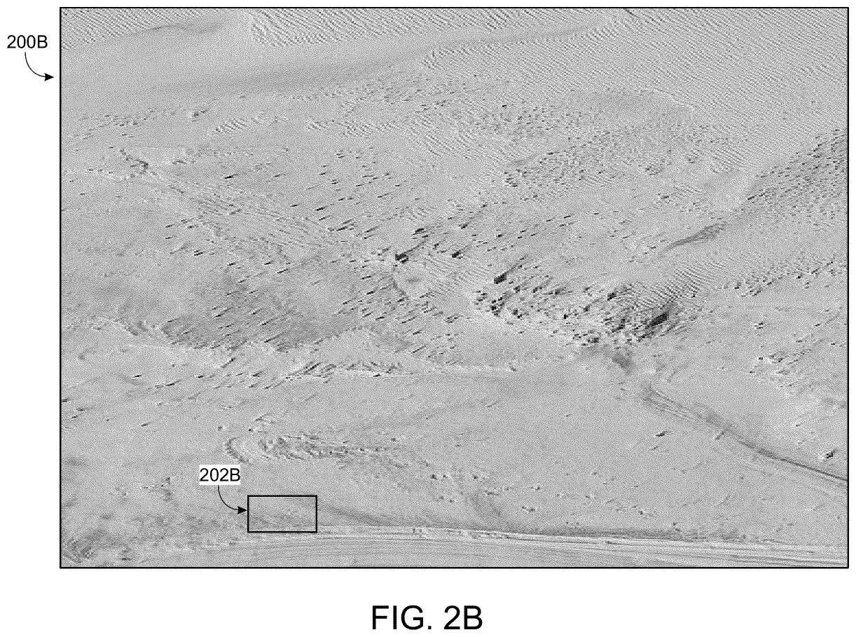

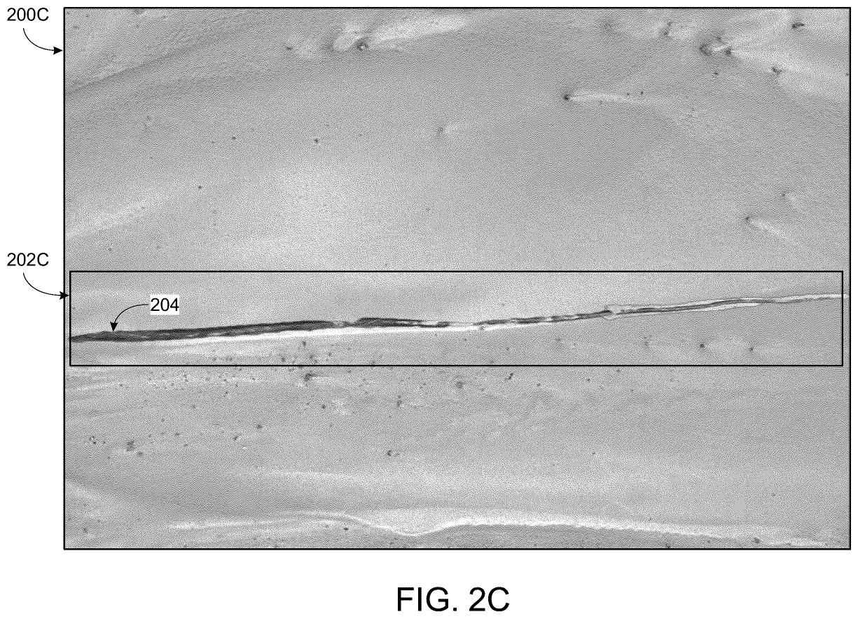

FIG. 2A illustrates an example of a first resolution image 200A, according to some implementations of the present disclosure. The resolution of the first resolution image 200A can be low-resolution. The first resolution image 200A can include an image of a region of interest, acquired by a remote sensing device. The region of interest can be a soil environment including one or more markers that are indicative of cables that were buried within the soil. The first resolution image 200A can have N₁=W₁*H₁ pixels (with width W₁ and height H₁), with each pixel having an associated spectrum consisting of C “channels” (or “bands”, or “dimensions”). For example, the first resolution image 200A can include multiple pixels, each representing a portion of the region of interest covering an area on the ground, ranging around hundreds of meters per pixel. The example of the first resolution image 200A can be captured by multispectral sensors that generate data in a few wavelength bands (e.g., 3 to 10 bands), such as red, green, blue, near infrared, and short-wave infrared. The example of a multi- or hyperspectral image 200A can help identify land cover, vegetation health, oil spills, sand encroachment, and water quality. The example of the first resolution image 200A can include hyperspectral imagery to provide detailed spectral information, facilitating identification of particular materials and respective unique signatures that can be compared to reference maps of materials to identify a suspect region 202A including major changes potentially indicative of cable exposure.

FIG. 2B illustrates an example of a second resolution image 200B, according to some implementations of the present disclosure. The resolution of the second resolution image 200B can be a mid-resolution. The second resolution image 200B can be an image of a portion of the region of interest, such as a suspect region 202A, described with reference to FIG. 2A, acquired by the remote sensing device. The suspect region 202A can be a portion of the soil environment including one or more markers that are indicative of cables that were buried within the soil. The second resolution image 200B can have N₂=W₂*H₂ pixels (with width W₂ and height H₂), with each pixel having an associated spectrum consisting of C “channels” (or “bands”, or “dimensions”). For example, the second resolution image 200B can include multiple pixels, each representing a portion of the region of interest covering an area on the ground, ranging from 5 to 100 meters per pixel. The example of the second resolution image 200B can include hyperspectral imagery to provide detailed spectral information, facilitating quantification of particular materials and respective unique signatures that can be compared to reference maps of materials to quantify changes within a suspect region 202B indicative of the cable exposure.

FIG. 2C illustrates an example of a third resolution image 200C, according to some implementations of the present disclosure. The resolution of the third resolution image 200C can be a high or an ultra-high resolution. The third resolution image 200C can be an image of suspect region 202B, described with reference to FIG. 2C, acquired by a remote sensing device. The third resolution image 200C can include be a portion of the soil environment 202C wherein a portion of a cable 204 is exposed. The third resolution image 200C can have N₃=W₃*H₃ pixels (with width W₃ and height H₃), with each pixel having an associated spectrum consisting of C “channels” (or “bands”, or “dimensions”). For example, the third resolution image 200C can include multiple pixels, each representing a portion of the region of interest covering an area on the ground, corresponding to centimeters or millimeters per pixel. The example of the third resolution image 200C can include hyperspectral imagery to provide detailed spectral information, facilitating quantification of a damage due to the cable exposure.

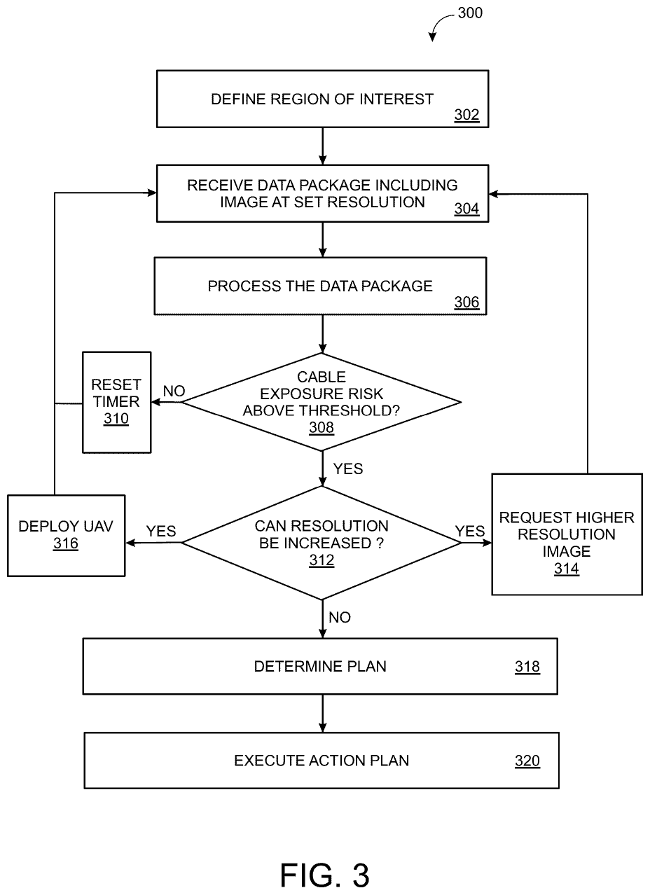

FIG. 3 depicts a flowchart illustrating an example process 300 for cable exposure identification, in accordance with some example embodiments. Referring to FIGS. 1A and 1B, the process 300 can be performed by any components of the example systems 100, 101.

At 302, a region of interest is defined. The region of interest can include a soil environment surrounding reference markers indicative of a trajectory of a buried cable used for communication networks. The region of interest can be a rectangular area within a set of rectangular areas distributed along the length of the buried cable, starting from a first communication node and ending at a second communication node. The reference markers can be physical markers or virtual markers, such as geolocation markers stored in a memory.

At 304, data package is received, by one or more processors, from a remote sensing device (e.g., remote sensing device 128 described with reference to FIG. 1A) configured to monitor the region of interest. The remote sensing device can be equipped with a multispectral image acquisition device. The data package can include remote sensing images of the region of interest and metadata. The metadata defines image characteristics including a set resolution of the remote sensing images and geographical area or reference markers corresponding to the image.

At 306, the data package is processed, by the one or more processors. Processing the data package can include processing the remote sensing images using a processing tool selected based on set resolution of the remote sensing images. Processing the remote sensing images can include image preprocessing. The image preprocessing can include image alignment and filtering. The filtering can include application of a multidimensional edge detection filter. In order to mask out the “impure” pixels, an edge detection filter can be applied first. Applying the edge detection filter can include a convolution with a 3×3 edge detection filter for detecting edges in grayscale images. The application of the edge detection filter can effectively measure the gradients Gₓ and G_{y} in the x- and y-directions respectively at each pixel, with the overall gradient measure for the pixel given by:

$$G = \sqrt{{G}_{x}^{2} + {G}_{y}^{2}}$$

The edge detection filter can be applied to a grayscale conversion of the multispectral image. The edge detection filter can include a Sobel filter or a Scharr filter. The 3×3 Scharr filter has a better rotational invariance than the Sobel filter. The Scharr filter can be the basis of the normalized multidimensional edge detection filter: The form of the Scharr filter for measurement of gradients in the x-direction is:

$${h}_{x}^{′} ( : , : ) = [ \begin{matrix}- 47 & 0 & 47 \\ - 162 & 0 & 162 \\ - 47 & 0 & 47\end{matrix} ]$$

The negative transpose of the filter is the Scharr filter in the y-direction. In order to apply Scharr filter to multi- and hyperspectral images, the x- and y-direction filters are both extended into a cuboid of length equal to the number D of bands in the image (e.g., 12 bands). Each 3×3 layer of the 3×3×D filters that result can contain the same values as above. In order for the resulting filter to be applied to the edge and corner pixels, linear interpolation can be used to extend the image by one pixel at the edges and corners for the top left corner of one band of the image. The linear interpolation can be done for all of the edge and corner pixels in all of the bands. Add a border around each band of the image by linearly interpolating the values by one pixel. The x- and y-direction Scharr filters can be applied band-by-band and pixel-by-pixel to the entire image to obtain G_{x[k]} and G_{y[k]} for each pixel where k denotes the band. For example, the formula for calculating G_{x[k]} by applying Gₓ to pixel (i,j) in band k of the image (where “I” is the x-coordinate “j” is the y-coordinate) is given by:

$${G}_{x [ k ]} = 37. * ( v [ i ] [ j ] [ k ] + v [ i ] [ j + 2 ] [ k ] - v [ i + 2 ] [ j ] [ k ] - v [ i + 2 ] [ j + 2 ] [ k ] ) + 162. * ( v [ i ] [ j + 1 ] [ k ] - v [ i + 2 ] [ j + 1 ] [ k ] ) ,$$

The term v[i][j][k] is the value of the pixel (i,j) in band k. The strength of the edge for a given pixels is then the square root of the sum over all bands of G_{x[k]}*G_{x[k]}+G_{y[k]}*G_{y[k]}. This can also be represented as a matrix convolution. The term G_{y[k]} is calculated for the pixel in band k in the same way, and the set of G_{x[k]} and G_{y[k]} over all bands is used to calculate the edge index G for the pixel. The process of masking out mixed pixels reduces the original S data samples/pixels to a portion (N) of samples that remain unmasked to facilitate material distribution change identification in the preprocessed images.

At 308, the identified change is classified, by the one or more processors to determine whether cable exposure risk is above threshold. The identified change can be classified, by an artificial intelligence model trained to analyze the preprocessed images. The preprocessed images can be processed using an artificial intelligence model corresponding to respective image resolution. For example, low resolution preprocessed images can be processed to determine changes correlated to cable exposure. Mid-resolution preprocessed images can be processed to determine a suspect region that can potentially include exposed cables. High-resolution preprocessed images can be processed to automatically identify a linear distribution of cable exposure along or adjacent to a geographical path of a buried cable. The identification of cable exposure can include the characterization off the cable damage, such as protection layer damage, length of cable exposure, and presence of potentially damaging materials within the suspect region. The artificial intelligence model can include a machine learning (ML) model or a deep learning (DL) model. The ML model can include supervised learning ML model or an unsupervised learning ML model. The supervised learning ML model uses labeled data to train models to recognize patterns in material distribution. Common algorithms include decision trees, support vector machines, and neural networks. The unsupervised learning ML model identifies patterns in data without predefined labels using techniques like clustering (e.g., K-means) and dimensionality reduction (e.g., PCA). The DL model can include convolutional neural networks (CNNs) or a generative model. The CNN model can analyze spatial patterns in images, such as sand migration patterns or material redistribution patterns that can be induced by weather events, such as air currents or water surges. The generative model can include generative adversarial networks (GANs) and variational autoencoders (VAEs), which can generate new data samples that mimic the distribution of the training data. The artificial intelligence model can be trained using historical data or synthetic generated data along with techniques comprising transfer-learning, multi-task learning, continual learning, supervised learning, un-supervised learning or domain-adaptation. The artificial intelligence model can quantify the cable exposure risk based on a comparison of the quantified material distribution change within a suspect region to a change threshold to determine whether the quantified change is greater or smaller than the change threshold. The change threshold can be a set value derived from historical material distribution changes within a soil environment type (e.g., desert) that was significantly correlated with cable exposure. The artificial intelligence model can quantify the cable exposure risk based on a comparison of the potentially exposed cable to one or more risk levels associated with cable exposure, the highest risk being associated to cables exposed along a distance exceeding an exposure distance and including identified protection layer damages.

At 310, in response to determining that the quantified risk is smaller than the threshold, a timer for acquiring subsequent remote sensing images is reset for continuing future monitoring of the region of interest. At 312, in response to determining that the quantified risk is greater than the threshold, it is determined whether a resolution of remote sensing images can be increased. For example, a current resolution of the received remote sensing images can be compared to a maximum resolution at which the remote sensing device that previously acquired images can acquire images.

At 314, in response to determining that the remote sensing device that previously acquired images is below a maximum image acquisition resolution, a trigger can be sent to acquire images at an updated resolution higher than the set resolution. In some implementations, the remote sensing device can receive multiple trigger signals to acquire images at multiple resolutions that can be increased stepwise from a low resolution to a medium resolution, from a medium resolution to a high resolution, and from a high resolution to an ultra-high resolution.

At 316, in response to determining that the remote sensing device that previously acquired images reached a maximum image acquisition resolution and an additional remote sensing device configured to acquire images at a higher resolution is available, the additional remote sensing device can be deployed to the region of interest. The additional remote sensing device can be an UAD that can acquire images at an updated resolution higher than the maximum image acquisition resolution of the initial the remote sensing device (e.g., satellite device). For example, the additional remote sensing device can acquire images, of a region identified as potentially including exposed cables, at ultra-high resolution. The ultra-high resolution images can be processed (at 306) to confirm cable exposure and to determine and quantify exposed cable damage, such as determining a damage of cable protection layer and a length of cable exposure.

At 318, an action plan defining an action and a corresponding surface equipment is determined, by the one or more processors. The action plan can be identified by machine learning models (e.g., recurrent neural networks with a multi-layer network topology) trained and fine-tuned to generate an automatic selection of an efficient remedial action (e.g., activation of one or more machines including excavators for safely digging trenches, machines for recoating exposed cables, and machines for reburying the exposed cables). The trained machine learning models can be configured to operate in active mode, for communication network protection, facilitating automatic action plan implementation. For example, the trained machine learning models can trigger an initiation of the action plan, and a modification of machine operations based on most recent map of exposed cables relative to the original pathways of buried cables of a communication network.

At 320, the action plan is automatically executed by generating a trigger, by the one or more processors, to activate an operation of a system or a machine configured to perform a remedy operation (e.g., digging, recoating, and reburying operation).

The example process 300 facilitates optimization of accurate generation of exposed cable map. One of the greatest benefits of hierarchal resolution imaging for generation of an accurate exposed cable map is that it optimizes resources dedicated to data processing. The example process 300 provides an activation of automatic remedial machine actions to ensure continuous data flow through communication networks. The example process 300 also provide resource conservation opportunities by minimizing computing system requirements and optimization of monitorization of cable exposure in remote soil environments.

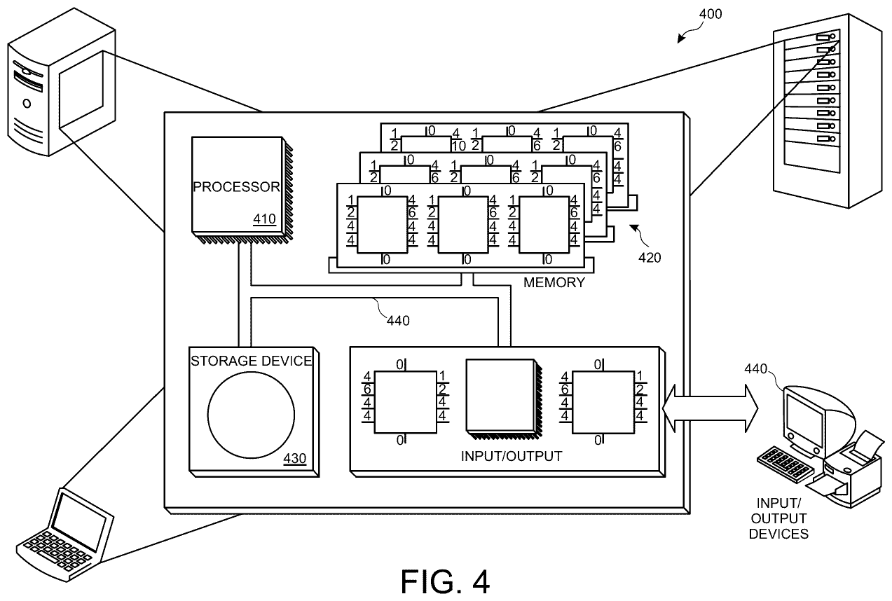

FIG. 4 depicts a block diagram illustrating a computing system 400, in accordance with some example embodiments. Referring to FIGS. 1A and 1B, the computing system 400 can be used to implement the server system 102 and/or any other components of the example system 100.

As shown in FIG. 4, the computing system 400 can include a processor 410, a memory 420, a storage device 430, and input/output devices 440. The processor 410, the memory 420, the storage device 430, and the input/output devices 440 can be interconnected using a system bus 450. The processor 410 is capable of processing instructions for execution within the computing system 400. Such executed instructions can implement one or more components of, for example, the example system 100. In some implementations of the current subject matter, the processor 410 can be a single-threaded processor. Alternately, the processor 410 can be a multi-threaded processor. The processor 410 is capable of processing instructions stored in the memory 420 and/or on the storage device 430 to display graphical information for a user interface provided using the input/output device 440.

The memory 420 is a computer readable medium such as volatile or non-volatile that stores information within the computing system 400. The memory 420 can store data structures representing configuration object databases, for example. The storage device 430 is capable of providing persistent storage for the computing system 400. The storage device 430 can be a floppy disk device, a hard disk device, an optical disk device, or a tape device, or other suitable persistent storage means. The input/output device 440 provides input/output operations for the computing system 400. In some implementations of the current subject matter, the input/output device 440 includes a keyboard and/or pointing device. In various implementations, the input/output device 440 includes a display unit for displaying graphical user interfaces.

According to some implementations of the current subject matter, the input/output device 440 can provide input/output operations for a network device. For example, the input/output device 440 can include Ethernet ports or other networking ports to communicate with one or more wired and/or wireless networks (e.g., a local area network (LAN), a wide area network (WAN), the Internet).

In some implementations of the current subject matter, the computing system 400 can be used to execute various interactive computer software applications that can be used for organization, analysis and/or storage of data in various (e.g., tabular) format (e.g., Microsoft Excel®, and/or any other type of software). Alternatively, the computing system 400 can be used to execute any type of software applications. These applications can be used to perform various functionalities, e.g., planning functionalities (e.g., generating, managing, editing of spreadsheet documents, word processing documents, and/or any other objects), computing functionalities, or communications functionalities. The applications can include various add-in functionalities or can be standalone computing products and/or functionalities. Upon activation within the applications, the functionalities can be used to generate the user interface provided using the input/output device 440. The user interface can be generated and presented to a user by the computing system 400 (e.g., on a computer screen monitor).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random-access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The preceding figures and accompanying description illustrate example processes and computer implementable techniques. The environments and systems described above (or their software or other components) may contemplate using, implementing, or executing any suitable technique for performing these and other tasks. It can be understood that these processes are for illustration purposes only and that the described or similar techniques may be performed at any appropriate time, including concurrently, individually, in parallel, and/or in combination. In addition, many of the operations in these processes may take place simultaneously, concurrently, in parallel, and/or in different orders than as shown. Moreover, processes may have additional operations, fewer operations, and/or different operations, so long as the methods remain appropriate.

In other words, although the disclosure has been described in terms of certain implementations and generally associated methods, alterations and permutations of these implementations, and methods will be apparent to those skilled in the art. Accordingly, the above description of example implementations does not define or constrain the disclosure. Other changes, substitutions, and alterations are also possible without departing from the spirit and scope of the disclosure.

A number of implementations of the present disclosure have been described. Nevertheless, it will be understood that various modifications may be made without departing from the spirit and scope of the present disclosure. Accordingly, other implementations are within the scope of the following claims.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application.

Example 1. A computer-implemented method for preventing data loss from cable exposure in an environment, the method comprising: receiving data corresponding to a region of interest, the data comprising remote sensing images of a region of interest and metadata comprising information indicative of a set resolution of the remote sensing images, the region of interest comprising at least partially buried cables; determining, by processing the data, a cable exposure risk within a portion of the region of interest; requesting an additional image at an updated resolution higher than the set resolution; receiving an additional data comprising additional remote sensing images corresponding to the portion of the region of interest; processing the additional remote sensing images to classify an exposure of at least a portion of a buried cable; and generating a control signal causing a remote device to remedy the exposure of the at least the portion of the buried cable and prevent data loss for data transmitted over the at least the portion of the buried cable.

Example 2. The computer-implemented method of the preceding example, wherein the remote sensing images comprise low resolution satellite images, mid-resolution satellite images, and high-resolution satellite images.

Example 3. The computer-implemented method of any of the preceding examples, comprising: determining that additional remote sensing images are acquirable at the updated resolution.

Example 4. The computer-implemented method of any of the preceding examples, further comprising: generating a trigger to acquire additional remote sensing images at the updated resolution, higher than the set resolution.

Example 5. The computer-implemented method of any of the preceding examples, comprising: in response to determining that the set resolution is a maximum resolution of the satellite images, generating a trigger to deploy an unmanned aerial device to the region of interest; receiving a confirmation of the exposure of the at least the portion of the buried cable; and generating an alert indicative of the exposure of the at least the portion of the buried cable.

Example 6. The computer-implemented method of any of the preceding examples, further comprising: deploying a machine to the region of interest.

Example 7. The computer-implemented method of any of the preceding examples, wherein classifying the exposure of the at least the portion of the buried cable comprises determining a damage of cable protection layer and a length of cable exposure.

Example 8. A computer-implemented system comprising: memory storing application programming interface (API) information; and a server performing operations comprising: receiving data corresponding to a region of interest, the data comprising remote sensing images of a region of interest and metadata comprising information indicative of a set resolution of the remote sensing images, the region of interest comprising at least partially buried cables; determining, by processing the data, a cable exposure risk within a portion of the region of interest; requesting an additional image at an updated resolution higher than the set resolution; receiving an additional data comprising additional remote sensing images corresponding to the portion of the region of interest; processing the additional remote sensing images to classify an exposure of at least a portion of a buried cable; and generating a control signal causing a remote device to remedy the exposure of the at least the portion of the buried cable and prevent data loss for data transmitted over the at least the portion of the buried cable.

Example 9. The computer-implemented system of the preceding example, wherein the remote sensing images comprise low resolution satellite images, mid-resolution satellite images, and high-resolution satellite images.

Example 10. The computer-implemented system of any of the preceding examples, wherein the operations comprise: determining that additional remote sensing images are acquirable at the updated resolution.

Example 11. The computer-implemented system of any of the preceding examples, wherein the operations comprise:

generating a trigger to acquire additional remote sensing images at the updated resolution, higher than the set resolution.

Example 12. The computer-implemented system of any of the preceding examples, wherein the operations comprise: in response to determining that the set resolution is a maximum resolution of the satellite images, generating a trigger to deploy an unmanned aerial device to the region of interest; receiving a confirmation of the exposure of the at least the portion of the buried cable; and generating an alert indicative of the exposure of the at least the portion of the buried cable.

Example 13. The computer-implemented system of any of the preceding examples, wherein the operations comprise: deploying a machine to the region of interest.

Example 14. The computer-implemented system of any of the preceding examples, wherein classifying the exposure of the at least the portion of the buried cable comprises determining a damage of cable protection layer and a length of cable exposure.

Example 15. A non-transitory computer-readable media encoded with a computer program, the computer program comprising instructions that when executed by one or more computers cause the one or more computers to perform operations comprising: receiving data corresponding to a region of interest, the data comprising remote sensing images of a region of interest and metadata comprising information indicative of a set resolution of the remote sensing images, the region of interest comprising at least partially buried cables; determining, by processing the data, a cable exposure risk within a portion of the region of interest; requesting an additional image at an updated resolution higher than the set resolution; receiving an additional data comprising additional remote sensing images corresponding to the portion of the region of interest; processing the additional remote sensing images to classify an exposure of at least a portion of a buried cable; and generating a control signal causing a remote device to remedy the exposure of the at least the portion of the buried cable and prevent data loss for data transmitted over the at least the portion of the buried cable.

Example 16. The non-transitory computer-readable media of the preceding example, wherein the remote sensing images comprise low resolution satellite images, mid-resolution satellite images, and high-resolution satellite images.

Example 17. The non-transitory computer-readable media of any of the preceding examples, wherein the operations comprise: determining that additional remote sensing images are acquirable at the updated resolution; and generating a trigger to acquire additional remote sensing images at the updated resolution, higher than the set resolution.

Example 18. The non-transitory computer-readable media of any of the preceding examples, wherein the operations comprise: in response to determining that the set resolution is a maximum resolution of the satellite images, generating a trigger to deploy an unmanned aerial device to the region of interest; receiving a confirmation of the exposure of the at least the portion of the buried cable; and generating an alert indicative of the exposure of the at least the portion of the buried cable.

Example 19. The non-transitory computer-readable media of any of the preceding examples, wherein the operations comprise: deploying a machine to the region of interest.

Example 20. The non-transitory computer-readable media of any of the preceding examples, wherein classifying the exposure of the at least the portion of the buried cable comprises determining a damage of cable protection layer and a length of cable exposure.

What is claimed is:

1. A computer-implemented method for preventing data loss from cable exposure in an environment, the method comprising:
receiving data corresponding to a region of interest, the data comprising remote sensing images of a region of interest and metadata comprising information indicative of a set resolution of the remote sensing images, the region of interest comprising at least partially buried cables;
determining, by processing the data, a cable exposure risk within a portion of the region of interest;
requesting an additional image at an updated resolution higher than the set resolution;
receiving an additional data comprising additional remote sensing images corresponding to the portion of the region of interest;
processing the additional remote sensing images to classify an exposure of at least a portion of a buried cable; and
generating a control signal causing a remote device to remedy the exposure of the at least the portion of the buried cable and prevent data loss for data transmitted over the at least the portion of the buried cable.

2. The computer-implemented method of claim 1, wherein the remote sensing images comprise low resolution satellite images, mid-resolution satellite images, and high-resolution satellite images.

3. The computer-implemented method of claim 1, comprising:
determining that additional remote sensing images are acquirable at the updated resolution.

4. The computer-implemented method of claim 3, comprising:
generating a trigger to acquire additional remote sensing images at the updated resolution, higher than the set resolution.

5. The computer-implemented method of claim 3, comprising:
in response to determining that the set resolution is a maximum resolution of the satellite images, generating a trigger to deploy an unmanned aerial device to the region of interest;
receiving a confirmation of the exposure of the at least the portion of the buried cable; and
generating an alert indicative of the exposure of the at least the portion of the buried cable.

6. The computer-implemented method of claim 1, comprising:
deploying a machine to the region of interest.

7. The computer-implemented method of claim 1, wherein classifying the exposure of the at least the portion of the buried cable comprises determining a damage of cable protection layer and a length of cable exposure.

8. A computer-implemented system comprising:
memory storing application programming interface (API) information; and
a server performing operations comprising:
receiving data corresponding to a region of interest, the data comprising remote sensing images of a region of interest and metadata comprising information indicative of a set resolution of the remote sensing images, the region of interest comprising at least partially buried cables;
determining, by processing the data, a cable exposure risk within a portion of the region of interest;
requesting an additional image at an updated resolution higher than the set resolution;
receiving an additional data comprising additional remote sensing images corresponding to the portion of the region of interest;
processing the additional remote sensing images to classify an exposure of at least a portion of a buried cable; and
generating a control signal causing a remote device to remedy the exposure of the at least the portion of the buried cable and prevent data loss for data transmitted over the at least the portion of the buried cable.

9. The computer-implemented system of claim 8, wherein the remote sensing images comprise low resolution satellite images, mid-resolution satellite images, and high-resolution satellite images.

10. The computer-implemented system of claim 8, wherein the operations comprise:
determining that additional remote sensing images are acquirable at the updated resolution.

11. The computer-implemented system of claim 10, wherein the operations comprise:
generating a trigger to acquire additional remote sensing images at the updated resolution, higher than the set resolution.

12. The computer-implemented system of claim 10, wherein the operations comprise:
in response to determining that the set resolution is a maximum resolution of the satellite images, generating a trigger to deploy an unmanned aerial device to the region of interest;
receiving a confirmation of the exposure of the at least the portion of the buried cable; and
generating an alert indicative of the exposure of the at least the portion of the buried cable.

13. The computer-implemented system of claim 8, wherein the operations comprise:
deploying a machine to the region of interest.

14. The computer-implemented system of claim 8, wherein classifying the exposure of the at least the portion of the buried cable comprises determining a damage of cable protection layer and a length of cable exposure.

15. A non-transitory computer-readable media encoded with a computer program, the computer program comprising instructions that when executed by one or more computers cause the one or more computers to perform operations comprising:
receiving data corresponding to a region of interest, the data comprising remote sensing images of a region of interest and metadata comprising information indicative of a set resolution of the remote sensing images, the region of interest comprising at least partially buried cables;
determining, by processing the data, a cable exposure risk within a portion of the region of interest;
requesting an additional image at an updated resolution higher than the set resolution;
receiving an additional data comprising additional remote sensing images corresponding to the portion of the region of interest;
processing the additional remote sensing images to classify an exposure of at least a portion of a buried cable; and
generating a control signal causing a remote device to remedy the exposure of the at least the portion of the buried cable and prevent data loss for data transmitted over the at least the portion of the buried cable.

16. The non-transitory computer-readable media of claim 15, wherein the remote sensing images comprise low resolution satellite images, mid-resolution satellite images, and high-resolution satellite images.

17. The non-transitory computer-readable media of claim 15, wherein the operations comprise:
determining that additional remote sensing images are acquirable at the updated resolution; and
generating a trigger to acquire additional remote sensing images at the updated resolution, higher than the set resolution.

18. The non-transitory computer-readable media of claim 17, wherein the operations comprise:
in response to determining that the set resolution is a maximum resolution of the satellite images, generating a trigger to deploy an unmanned aerial device to the region of interest;
receiving a confirmation of the exposure of the at least the portion of the buried cable; and
generating an alert indicative of the exposure of the at least the portion of the buried cable.

19. The non-transitory computer-readable media of claim 15, wherein the operations comprise:
deploying a machine to the region of interest.

20. The non-transitory computer-readable media of claim 15, wherein classifying the exposure of the at least the portion of the buried cable comprises determining a damage of cable protection layer and a length of cable exposure.
